(19) United States
(12) Patent Application Publication
(10) Pub. No.: US 2005/0125123 A1
(43) Pub. Date: Jun. 9, 2005

(54) On-vehicle rear-seat display device

(75) Inventor: Tatsumi Kageyama, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 11/004,059

(22) Filed: Dec. 6, 2004

(30) Foreign Application Priority Data
Dec. 9, 2003 (JP) 2003-410635

(51) Int. Cl. G06F 17/00

(52) U.S. Cl. 701/36; 701/1; 307/10.1

(57) ABSTRACT

A camera is built in a DVD mechanical portion or a display portion of a rear entertainment system, and the camera takes a passenger sat in a rear seat or his or her situations, or a backward scene of the vehicle seen from the rear seat as a moving image or a still image. The picked up video signals are subjected to image processing by an image processor, and are displayed thereon. Moreover, when recording the image taken by the camera, the image is recorded in a recording part as a moving image or a still image according to an input operation via a key input portion. Further, the image taken by the camera is also sent to a front seat navigation-monitor portion, and displayed thereon.

### BACKGROUND OF THE INVENTION

1. Field of the Invention

The present invention relates to an on-vehicle rear-seat display device whose functionality is extended by mounting a camera to image a rear seat or a rearward scene of a vehicle and by displaying an image taken by the camera on the display device.

2. Description of the Related Art

For example, there are following on-vehicle rear-seat display devices for the convenience of a passenger sat in a rear seat of a vehicle as typical conventional ones.

JP 11-129815 A discloses, e.g., an on-vehicle rear-seat display device arranged such that in case of normal driving, a display face of the device is turned toward a direction where the face thereof can be watched by the passenger and the display face displays thereon television broadcasts etc. Per contra, in case of back ward movement, a direction of the display face is turned such that the face can be watched by a driver with his or her face turned rearward and in a visual check posture, and an image sent from a surveillance camera taking a rearward dead angle is displayed on the display so that a driver can also check safety of the dead angle by watching the displayed image.

Further, JP 11-291817 A discloses, e.g., an on-vehicle rear-seat display device arranged to simply display a reproduced image from a DVD (digital video disk) etc. for a passenger seated in the rear seat.

The conventional on-vehicle rear-seat display device has been arranged as mentioned above. As a result, it has merely limited functions, from the viewpoint of functions to be properly furnished to the display device, including just the functions of displaying an image of a TV broadcast, a reproduced image of a DVD etc., a camera image used for a safety check for a rearward of the vehicle, and a navigation image. Accordingly, the display device has no function other than the above.

### SUMMARY OF THE INVENTION

The present invention has been made to solve the above-mentioned problems. An object of the present invention is to provide an on-vehicle rear-seat display device whose functionality is extended so as to use the display device as, e.g., a mirror, by mounting a camera and possessing functions of taking a passenger sat in a rear seat and his or her situations, or a rearward scene of the vehicle, seen from the rear seat, by the use of the camera.

The on-vehicle rear-seat display device according to the present invention includes a camera that takes a rear seat of a vehicle or a rearward scene of the vehicle; and a display portion that is disposed so as a passenger may watch the display portion, and displays thereon video signals generated by the camera after having been subjected to image processing.

Therefore, according to the present invention, it is arranged such that a passenger et al. sat in the rear seat is taken by the camera, and the image is displayed on the display portion provided for the passenger. It follows that an extension of functionality of the on-vehicle rear-seat display device can be achieved on account of its versatility that the passenger can not only display his or her own image on the display portion to use the image as, e.g., a mirror, but also use also taking and displaying functions as a plaything for children.

### BRIEF DESCRIPTION OF THE DRAWINGS

FIG. 1 is a block diagram showing a configuration of a rear entertainment system according to a first embodiment of the present invention;

FIG. 2 is a block diagram showing a configuration of an image processor in the rear entertainment system shown in FIG. 1;

FIG. 3 is a view showing an exemplary case in which the rear entertainment system and a front-seat navigation monitor are mounted on an actual vehicle;

FIG. 4 is a view showing exemplary cases of actual mounting positions of a camera shown in FIG. 3; and

FIG. 5 is a flow chart showing an operation of the rear entertainment system according to a first embodiment.

### DETAILED DESCRIPTION OF THE PREFERRED EMBODIMENTS

A preferred embodiment of the present invention will now be described below with reference to the accompanying drawings.

### First Embodiment

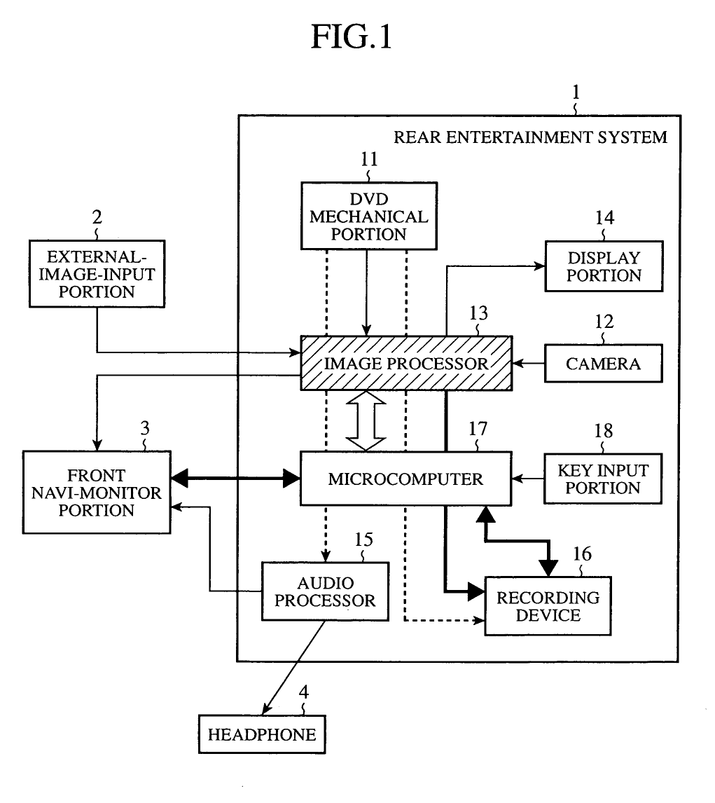

FIG. 1 is a block diagram showing a configuration of an on-vehicle rear-seat display device (hereinafter referred to as a “rear entertainment”) according to the first embodiment of the present invention.

In FIG. 1, the rear entertainment 1 includes a DVD mechanical portion 11 that reproduces video signals recorded in a DVD, and outputs the signals; a camera 12 that takes a passenger seated in a rear seat and his or her situations, or a rearward scene of the vehicle seen from the rear seat, as a moving image or a still image; an image processor 13 that applies signal processing to the reproduced video signals from the DVD mechanical portion 11, the video signals generated by the camera 12, and further input video signals from an external image-input portion 2 that inputs a variety of external video signals; a display portion 14 such as a liquid crystal display (LCD) that displays video signals processed by the image processor 13; an audio processor 15 that applies signal processing to the reproduced audio signals from the DVD mechanical portion 11, and outputs the audio signals; a recording device 16 that records the video signals processed by the image processor 13 as a moving image or a still image; a microcomputer (hereinafter referred to as a “micon”) 17 that controls the image processor 13 and the recording device 16, and serves as the control center of the rear entertainment; and a key input portion 18 that does a necessary input operation to the microcomputer 17.

For that matter, the micon 17 and the image processor 13 which is under the control of the micon 17 constitute image processing means, and the micon 17 and the recording device 16 which is under the control of the micon 17 constitute recording means.

Further, the key input portion 18 includes a remote controller (hereinafter referred to as a “remocon”) responsible for a remote control of the rear entertainment, in addition to a key input portion placed on the main body side.

It is advisable for recording medium used in the recording device 16 to be detachable from the recording device 16. The detachable recording medium may, e.g., be a hard disk (HD), a memory stick, and a DVD-R etc.

Such detachability thereof enables the recorded image to be played back by another device for confirmation. For example, it is able to record the image in a hard disk, and played back the hard disk by a personal computer etc.

Moreover, as shown in FIG. 1, the rear entertainment 1 is connected with an external image-input portion 2, a navigation monitor portion 3 provided in the front seat of the vehicle (hereinafter referred to as a “front navi-monitor portion”) and a headphone 4.

Herein, the external-image-input portion 2 is for inputting signals of a navigation image, a TV broadcast image, and a reproduced image of a VTR (video tape recording device) to the image processor 13 of the rear entertainment 1.

The front navi-monitor portion 3 transmits a control signal to and receives it from the micon 17 of the rear entertainment 1. Further, the video signals are supplied from the image processor 13 to the front navi-monitor portion in response to the control signal, and displayed on the monitor screen. In addition to the video signals, audio signals processed by the audio processor 15 are also input to the front navi-monitor portion 3, and output voice from the speaker (not shown).

Moreover, the audio signals processed by the audio processor 15 can also be listened by the headphone 4.

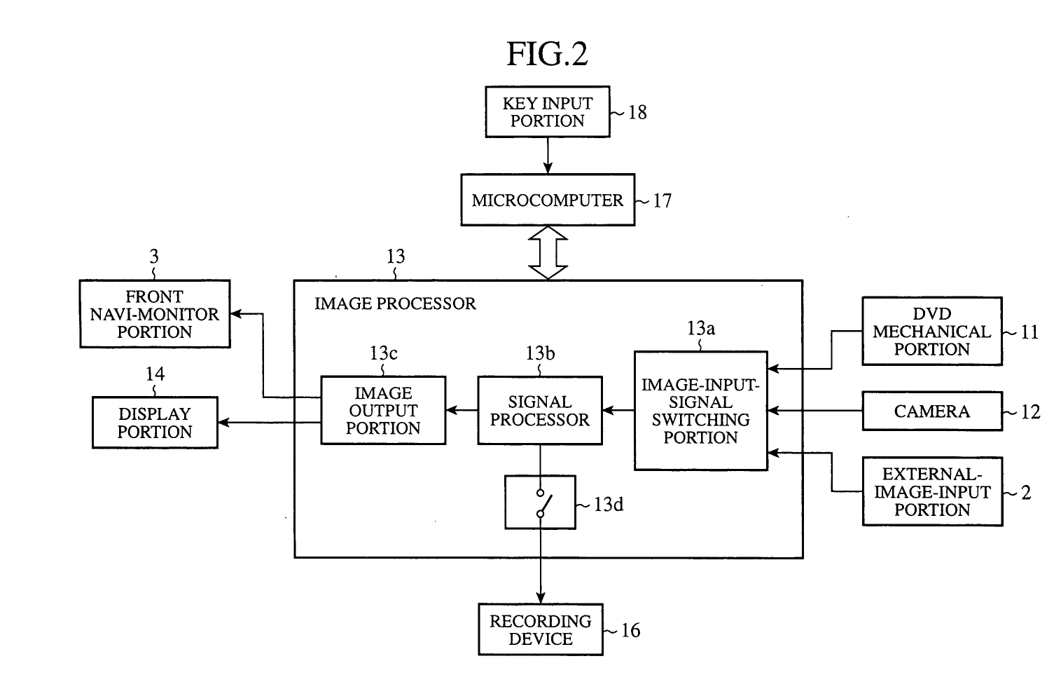

An explanation of the above-mentioned image processor 13 will now be given by reference to FIG. 2.

FIG. 2 is a block diagram showing a configuration of the image processor 13. In FIG. 2, the same reference numerals as in FIG. 1 designate the same components.

The image processor 13 includes an image-input signal switching portion 13a that selects a desired video signal from among those input by each of the DVD mechanical portion 11, the camera 12, and the external image-input portion 2; a signal processor 13b that processes the video signals from the image-input signal switching portion 13a to change the video signals into ones having a necessary level or required characteristics; an image output portion 13c that outputs the video signals processed by the signal processor 13b to the display portion 14 and the front navi-monitor portion 3; and a record on-off switch 13d that selects whether or not the video signals processed by the signal processor 13b are recorded in the recording device 16.

The selection of the image-input signal switching portion 13a, or On (“Record”) or Off (“Not record”) of the record on-off switch 13d are set by the micon 17 according to an operation of the key input portion 18 manipulated by an operator.

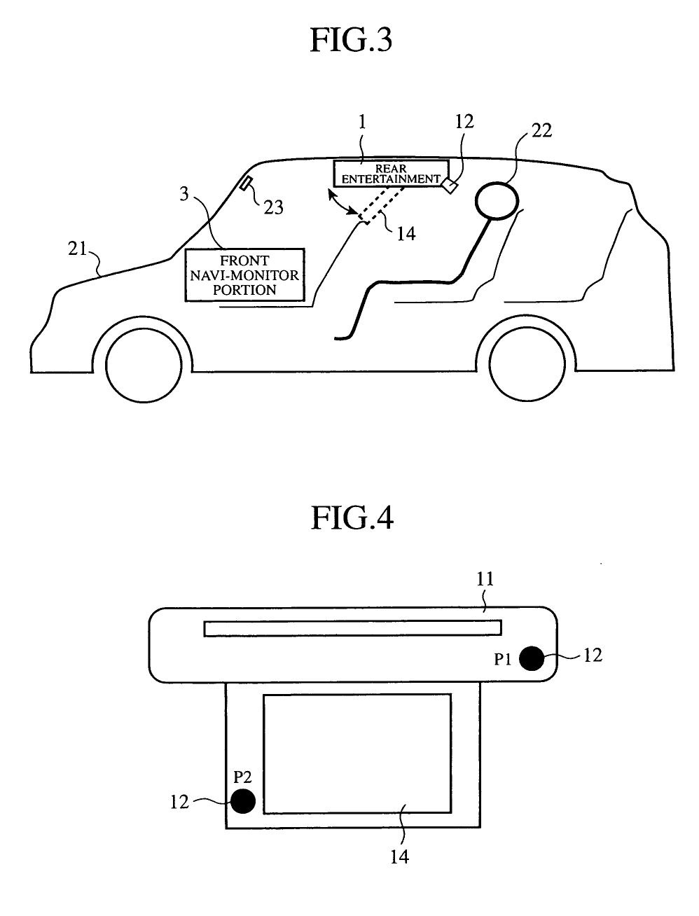

The explanation of FIG. 3 will then be given below.

FIG. 3 is a view showing an exemplary case in which the above-described rear entertainment 1 and a front navi-monitor 3 are mounted on an actual vehicle.

As shown in FIG. 3, the rear entertainment 1 is installed in a rear-seat ceiling portion in a vehicle 21. On this rear entertainment 1, the camera 12 is attached and the camera 12 takes a face of a passenger sat in a rear seat 22, and his or her situations, and further a backward scene of the vehicle seen from the rear seat. The camera 12 is arranged so as to freely change its direction (angle).

Moreover, the display portion 14 constituting the rear entertainment 1 is an opening-closing and housing type, and has an ability to freely change its angle of the display face manually or by a remote operation via the key input portion 18 of the remocon etc.

Further, the front seat of the vehicle is equipped with the front navi-monitor portion 3.

The explanation of FIG. 4 will next be given below.

FIG. 4 is a view showing an exemplary case of an actual mounting position of the camera 12 shown in FIG. 3. FIG. 4 shows either case where the camera 12 is built in a position P1 of the DVD mechanical portion 11, or case where a camera is incorporated into a position P2 of the display portion 14. In FIG. 4, both of them may be possible.

In particular, in case where the camera 12 is incorporated into the position P2 of the display portion 14, the display portion 14 has an advantage of freely selecting its direction (angle) of the camera 12 as well in that an angle of the display face of the display portion 14 can be freely changed as described with respect to FIG. 3.

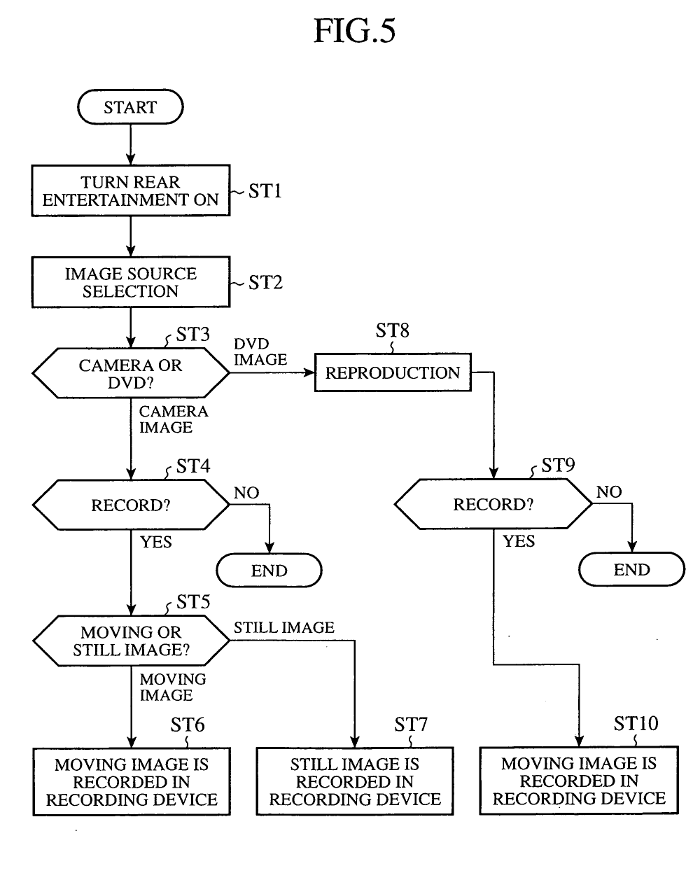

The operation of the rear entertainment will in turn be explained by reference to FIG. 5. FIG. 5 is a flow chart explaining an operation of the rear entertainment 1. In this connection, in FIG. 5, an explanation will be given by presuming an image source to be two channels: a picked up image by the camera 12 and a reproduced image from the DVD mechanical portion 11.

In step ST1, the rear entertainment 1 is powered (On) to be put in motion.

In step ST2, an image source is selected. As to which image source is selected is determined according of an input operation of the key input portion 18 manipulated by an operator. The micon 17 sets up, according to the input operation, the image input signal switching portion 13a of the image processor 13 so as to choose either of a picked up image including a moving image or a still image taken by the camera 12 or an image reproduced from the DVD mechanical portion 11. Video signals selected according to the setting are subjected to signal processing by the signal processor 13b, and are sent from the image output portion 13c to the display portion 14 to display thereon. Also, audio signals are processed by the audio processor 15, and are output to the headphone 4.

In addition, based on an input operation of the key input portion 18, the micon 17 can send video signals which are subjected to signal processing from the image output portion 13c of the image processor 13 to the front navi-monitor portion 3, and displays the processed signals thereon.

In step ST3, the micon 17 judges whether the selected video signal is derived from the camera 12 or from the DVD mechanical portion 11. This judgment can be made on the basis of a set instruction by a key input operation to the micon 17 in the step ST2.

When it is revealed in the step ST3 that an image originates from the camera 12, the processing proceeds to step ST4.

Instep ST4, the micon 17 judges whether or not the selected image taken by the camera 12 is to be recorded in the recording device 16. This judgment can be made on the basis of an input operation signal input to the record on-off switch 13d from the key input portion 18. That is, if the input operation signal from the key input portion 18 is a signal instructing to turn the record on-off switch 13d Off (Open), the judgment results in “Not record,” or else if the signal is a signal instructing to turn the switch On (Close), the judgment results in “Record”.

If the above judgment turned out to be “Not record” (step ST4-NO), the micon 17 turns the record on-off switch 13d Off (Opening) and terminates the processing. In this case, as explained in step ST2, an image taken by the camera 12 is sent to the display portion 14 through the image processor 13, and displayed thereon.

By contrast, if the above judgment proved to be “Record” (step ST4-YES), the processing proceeds to step ST5. In this case, the micon 17 turns the record on-off switch 13d On (Close).

In step ST5, the micon 17 judges whether or not an image taken by the camera 12 is a moving image or a still image. This judgment is made by detecting, e.g., whether there is any motion in an image of the image processor 13.

In the judgment, if the image turned out to be a “moving image”, the processing proceeds to step ST6; or else if it proved to be a “still image”, the processing proceeds to step ST7.

In step ST6, the micon 17 sets up the recording device 16 to record a moving image, and causes the recording device to record the moving image.

Further, in step ST7, the micon 17 sets up the recording device 16 to record a still image, and causes the recording device to record the still image.

In contrast to the above operations, if, in the step ST3, it is revealed that the image is originated from the DVD mechanical portion 11, the processing proceeds to step ST8.

In step ST8, the DVD is reproduced from the DVD mechanical portion 11, and the reproduced video signals are output to the image processor 13.

In step ST9, the micon 17 judges whether or not the selected image from the DVD mechanical portion 11 is to be recorded in the recording device 16. This judgment is made following the procedure as explained in step ST4.

If the judgment turned out to be “Not record” (step ST9-NO), the micon 17 turns the record on-off switch 13d Off (Opening), and terminates the processing. In this case, as explained in step ST2, the image reproduced from the DVD mechanical portion 11 is sent to the display portion 14 through the image processor 13, and is displayed thereon.

By contrast, if the above judgment turned out to be “Record” (step ST9-YES), the processing proceeds to step ST10. In this case, the micon 17 sets the record on-off switch 13d to On (Close).

In step ST10, the micon 17 sets up the recording device 16 to record a moving image, and causes the recording device to record the moving image.

As the recording medium used for recording the image in the step ST6, step ST7, or step ST10, a hard disk (HD), a memory stick, a DVD-R etc., which is detachable from the recording device 16, may be used as described above.

In FIG. 5, although the operation is explained by assuming the imahe source to be two channels: a picked up image by the camera 12 and a reproduced image from the DVD mechanical portion 11, other image sources such as a TV broadcast image, a VTR image, and a navigation image have only to be processed in accordance with the reproduced image from the DVD mechanical portion 11.

As mentioned above, through the configuration according to the first embodiment in which it is arranged such that the camera 12 is built into the DVD mechanical portion 11 or into the display portion 14 of the rear entertainment 1; the camera 12 takes a passenger sat in the rear seat and his or her situations, or a rearward scene of the vehicle seen from the rear seat as a moving image or a still image; and the picked up image is subjected to image processing and displayed on the display portion 14, the device enables an occupant seated in the rear seat to use the display portion as a mirror, e.g., in case of woman's makeup fixation, or to use also taking and displaying functions as a plaything for children, thereby extending functionality required to the rear entertainment 1.

Moreover, through the configuration according to the first embodiment in which the rear entertainment is arranged such that a moving image or a still image taken by the camera 12 is also displayed on the front navi-monitor portion 3, the camera allows a check for the bearings of the situation of a passenger, or a safety check whether or not the passenger fastens a seat belt via the monitor display.

Further, when the opening-closing type display portion 14 mounted on a rear ceiling is opened and is set to be in use, the display portion comes to obstruct a backward visibility of a room mirror 23 of a driver's seat. However, in this case, a backward scene of the vehicle is taken by the camera 12, and the image is displayed on the front navi-monitor portion 3, so that it will be served in place of a room mirror 23 of the driver 's seat, thereby permitting a safety check for a rearward of the vehicle.

Furthermore, through the configuration according to the first embodiment in which it is arranged such that a variety of images such as an image taken by the camera 12 and an image reproduced from the DVD mechanical portion 11 are recorded in the recording device 16, the device gives a convenience that a desired image can be stored, and played back later for his or her amusement.

Additionally, the recording media used in the recording device 16 is selectable out of a hard disk (HD), a memory stick, and a DVD-R etc., which is detachable from the recording device 16. Therefore, this may have freedom to reproduce the recorded image by another device for confirmation. To put it concretely, it is accomplished by, e.g., recording an image in the hard disk, and playing back the disk by a personal computer.

Further, the rear entertainment 1 can be used as a camera by recording a still image in the recording medium and then printing it out.

In addition, when attempting to build the camera 12 into the display portion 14 having a function of freely changing an angle of a display face by means of a remote control etc., the direction (angle) of the camera 12 can be freely adjusted by changing the angle of the display face.

1. An on-vehicle rear-seat display device comprising:
a camera that takes a rear seat of a vehicle or a rearward scene of the vehicle;
image processing means for processing video signals of the image generated by the camera; and
a display portion that is disposed for the sake a passenger sat in a rear seat of the vehicle, and displays thereon the video signals generated by the camera sent from the image processing means.

2. The on-vehicle rear-seat display device according to claim 1, wherein the image processing means transmits the video signals generated by the camera to a navigation monitor portion disposed in a front seat of the vehicle, and displays the signals thereon.

3. The on-vehicle rear-seat display device according to claim 1, further comprising recording means for recording the video signals subjected to image processing by the image processing means in a recording medium.

4. The on-vehicle rear-seat display device according to claim 3, wherein the recording medium is detachable from the recording means.
